(19) United States
(12) Patent Application Publication
(10) Pub. No.: US 2023/0150631 A1
(43) Pub. Date: May 18, 2023

(54) FLUID DRAWING INDUCTION MOTOR

(71) Applicant: OPEN INDUCTIONS PTY LTD, Queensland (AU)

(72) Inventor: Rizal Ibrahim Salib EVANS, Queensland (AU)

(21) Appl. No.: 17/915,139

(22) PCT Filed: Mar. 29, 2021
(86) PCT No.: PCT/AU2021/050276

§ 371 Date: Sep. 28, 2022

(30) Foreign Application Priority Data
Apr. 2, 2020 (AU) 2020901019

(51) Int. Cl. B63H 1/16; B64C 11/20; B64D 27/24; H02K 17/12; H02K 17/16; H02K 7/14; H02K 9/06; H02K 7/00; H02K 9/19; B64C 11/00

(52) U.S. Cl. CPC B63H 1/16; B64C 11/20; B64D 27/24; H02K 17/12; H02K 17/165; H02K 7/14; H02K 9/06; H02K 7/003; H02K 9/19; B64C 11/001

(57) ABSTRACT

The present invention relates to an electrical aircraft engine. The engine includes a stator with windings for generating a rotating magnetic field. The engine further includes a rotor for rotating inside or outside the stator. The rotor has a fan or propeller including thrust blades. The fan or propeller defines a closed-loop conductor. Advantageously, the thrust blades may generate direct thrust by moving fluid (i.e. gas or liquid), instead of driving a drive shaft, in turn, coupled to thrust blades.

### TECHNICAL FIELD

The present invention relates to a fluid drawing induction motor. The present invention has particular, although not exclusive application to an electrical aircraft engine.

### BACKGROUND

The reference to any prior art in this specification is not, and should not be taken as an acknowledgement or any form of suggestion that the prior art forms part of the common general knowledge.

To date when electric aircrafts are made, they invariably use an electric motor primarily an induction motor connected with a drive shaft to a propeller. Thrust is successfully created by converting electrical work into shaft work via electromagnetic induction. In turn, the shaft work is then converted into thrust by connecting the drive shaft of the motor to a propeller. Although a simple concept, it has proven to be very challenging to scale up, primarily due to the sheer size of the motor required.

For example, to provide enough thrust for a Boeing 737 max, a 4,000,000-watt electric motor is the minimum amount that is needed. A 400,000-watt induction motor already has a diameter of around 800 mm. To scale such a motor up by a factor of ten would further increase the size.

The motor shaft would have to be connected to a fan. Further, the fan and motor would have to fit the wing clearance from the ground. The bigger the motor power required, the bigger the motor, and the less area there is for the fan. Hence it would be extraordinarily difficult to fit an arrangement of this type under the wing of any existing kind of aircraft model.

As a result, it is difficult to propel commercially sized aircraft using the formulation of electric motors that currently exist. In addition to the size, the weight of the motor would also have a great effect. The current Boeing 737 Max uses the CFM leap 1-B. This is a turbofan engine that weighs approximately 2.8 tons. While a 400,000-watt electric motor already weighs 1.8 tons, hence a 4,000,000 watt-electric motor would be many times heavier. Due to the constraints of space and weight incorporating an induction motor or electric motor to propel a Boeing 737 Max, it is not only most challenging to retrofit on the existing wing structures but also pointless as it does not offer much benefit in terms of thrust production as well.

The preferred embodiment provides an improved electrical aircraft engine.

### SUMMARY OF THE INVENTION

According to one aspect of the present invention, there is provided an electrical aircraft engine including:

a stator with windings for generating a rotating magnetic field; and

a rotor for rotating inside or outside of the stator, the rotor having a fan or propeller including thrust blades, the fan or propeller defining a closed-loop conductor.

Advantageously, the thrust blades may generate direct aircraft thrust by moving fluid (i.e. gas or liquid), instead of driving a drive shaft, in turn, coupled to thrust blades. The thrust blades may be substantially located inside or outside the stator to form a compact design.

The tip or base of the fan blades may define a skew angle of the rotor. The blades may include aluminum, composite material with graphene coating, titanium material with silver coating fan blades, or any combination of conductive and ferromagnetic materials.

The fan may be integrally formed as a single piece. The fan may include a ferromagnetic material, conductive material or a combination of both.

The electrical aircraft engine may further include at least one electrical short for shorting the blades of the fan or any part of the fan including the hub.

The short may include any part of the hub. The short may include the base of the blade that is shorted through hub connections in the hub. The short may include a link (e.g. shroud) for linking the blades, preferably the tips of the blades. The link may include a ring made of a conductive material, ferromagnetic material, or a combination of both.

Preferably, the engine includes two shorts. The shorts may be concentric with the fan in-between.

The rotating magnetic field can be generated via a 1-phase, 2-phase, 3-phase or multiple-phase electricity supply.

According to another aspect of the present invention, there is provided an aircraft, including one or more of the engines arranged. The engines will change the pressure of a fluid (i.e. gas or liquid) resulting in the movement of the aircraft.

The engines may be arranged in series, or cascade or parallel with the fans directly adjacent each other.

According to another aspect of the present invention, there is provided a fan for a rotor, the fan including thrust blades and the entire fan defining a closed-loop conductor.

According to another aspect of the present invention, there is provided a fluid drawing induction motor including:

a stator with windings for generating a rotating magnetic field; and

a rotor for rotating inside or outside the stator, the rotor having a fan including thrust blades, the fan or components of the fan defining a closed-loop conductor.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic view of an electrical aircraft engine in accordance with an embodiment of the present invention;

FIG. 2 shows (a) front and (b) side views of a composite fan of the engine of FIG. 1; and

FIG. 3, shows (a) whole fan and (b) the hub of the fan, where the fan blades or primarily the base of the fan blade is made of a conductive material and is shorted via a hub connection where the hub consists of both ferromagnetic and conductive materials.

FIG. 4, shows (a) internal stator and (b) external stator. The internal stator will have a rotor rotating around it while the external stator will have a rotor rotating within it.

### DETAILED DESCRIPTION OF PREFERRED EMBODIMENTS

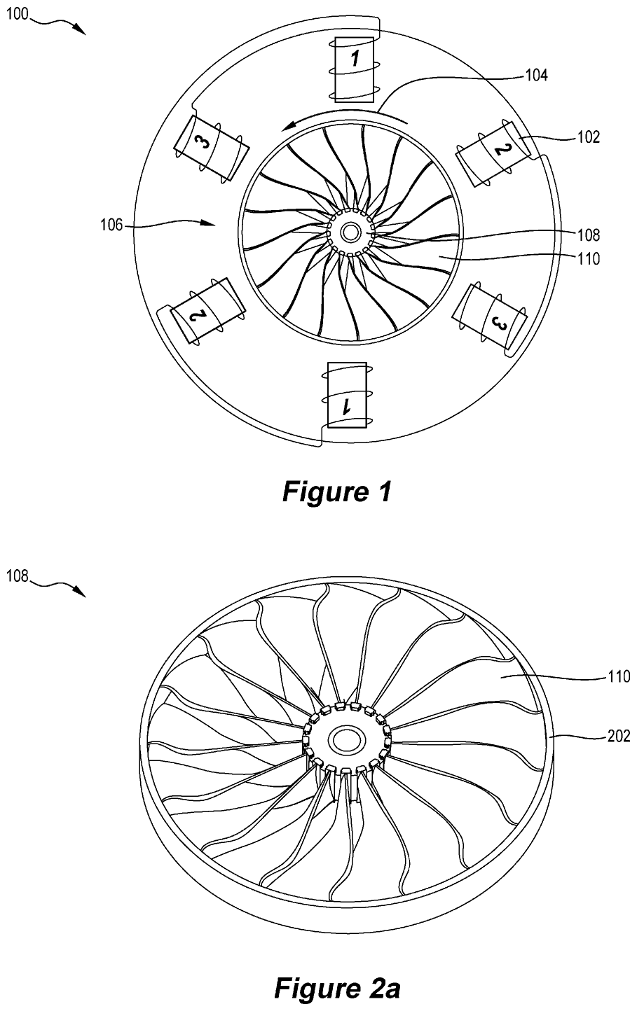

According to an embodiment of the present invention, there is provided a lightweight electrical aircraft engine 100 as shown in FIG. 1. The engine 100 includes a stator consisting of thin steel laminations 102 with induction windings for generating a rotating magnetic field 104. The engine 100 further includes a rotor 106 for rotating inside or outside the stator 102 responsive to the magnetic field 104. The rotor 106 has a fan 108 including thrust blades 110. The fan 108 defines a closed-loop conductor.

Advantageously, the thrust blades 110 generate direct thrust by moving fluid (i.e. gas or liquid), instead of otherwise driving a drive shaft (not present), in turn, coupled to thrust blades. The thrust blades 110 are located within the stator 102 but can also be located around the stator 102 to form a compact design.

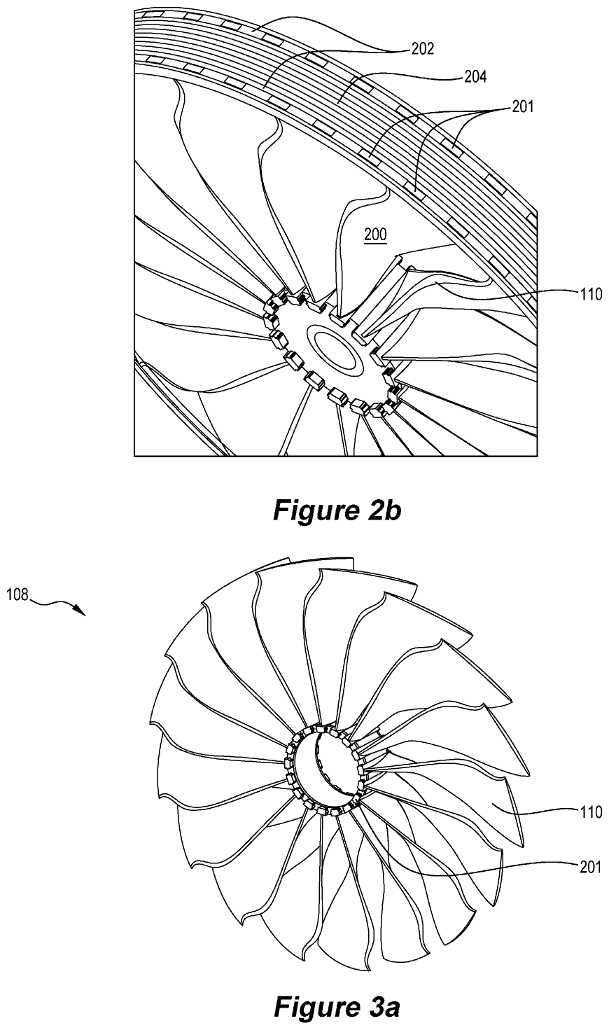

FIG. 2 shows a composite fan 108 of the engine 100 of FIG. 1. The conductive fan 108 is assembled of multiple parts, combining both ferromagnetic material and conductive materials. The blades 110 could be made of aluminum, composite material with graphene coating, titanium material with silver coating fan blades, composites, or any combination of conductive and ferromagnetic materials.

As can best be seen in FIG. 2(b), the tip of the blades 110 can define a skew angle 200 of the rotor 106.

The electrical aircraft engine 100 further includes two concentric electrical shorts 202 for shorting the conductive blades 110 of the fan 108 to form the closed-loop conductor. The fan 108 is located between the spaced apart shorts 202.

An outer short 202 includes a shroud (i.e. link) for linking the tips of the blades 110. The outer short 202 includes a ring made of a conductive material. In particular, the fan 108 is shroud shorted at the blade tips with a conductive material in this case being two copper rings separated by ferromagnetic material in the form of multiple steel laminations 204. The two copper rings 202 will have multiple conductor bars 201 and will act like a squirrel cage induction motor.

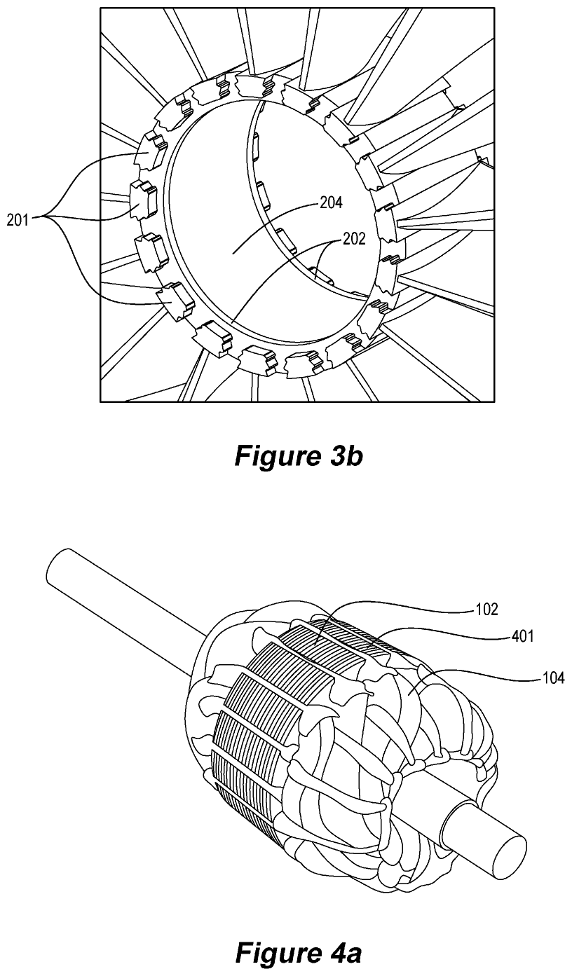

Turning to FIG. 3, the inner short includes a hub made of two rings made of a conductive material 202 separated by a lamination of ferromagnetic sheets 204 which will also act as base of the blades 110 extend from. In effect, the conductive rings 202 acts as means of shorting out the fan 108, and the base of the fan itself will act as conductor bars 201. When the hub 202, 204 and the conductor bars 201 in addition to the blades, this will act as a new form of squirrel cage induction motor.

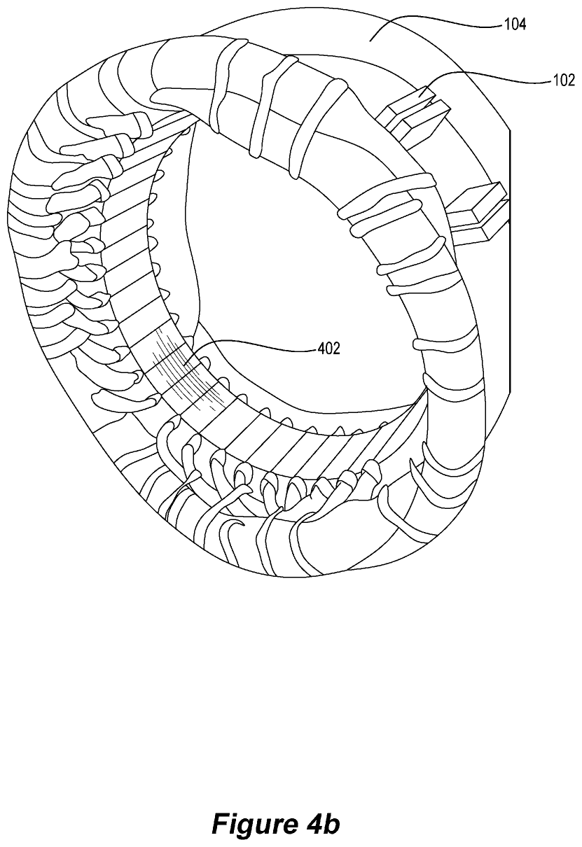

Turning to FIG. 4, the rotating magnetic field 104 can be generated via a 1-phase, 2-phase, 3-phase or multiple-phase electricity supply. The rotating magnetic field 104 can either be an external magnetic rotating field 401 or an internal rotating magnetic field 402. The external rotating magnetic field will have a more concentrated magnetic field radiating outwards of the stator, while the internal rotating magnetic field 402 will have a more concentrated magnetic field radiating inward. By using this form of induction motor, it allows more control when compared to a DC motor. The revolutions produced by an induction motor can be regulated by the frequency, while the torque can be controlled via the current in the windings. Hence the motor can have constant revolutions, while the torque can be changed. As a result, the fan 108 will operate with higher efficiency. In essence, instead of using the electric rotor 106 to produce shaft work, the rotor 106 directly moves any form of fluid (both gas and liquid) to create thrust.

In practice, an aircraft can include one or more of the engines 100 arranged to change the pressure of a fluid (i.e. gas or liquid) and induce movement of the aircraft. The engines 100 can be arranged in series, or cascade or parallel with the fans 108 directly adjacent each other.

Throughout the description, the term conductor means electrical conductor.

A person skilled in the art will appreciate that many embodiments and variations can be made without departing from the ambit of the present invention.

In compliance with the statute, the invention has been described in language more or less specific to structural or methodical features. It is to be understood that the invention is not limited to specific features and applications shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

The claims defining the invention are as follows:

1. An electrical aircraft engine including:
a stator with windings for generating a rotating magnetic field; and
a rotor for rotating inside or outside the stator, the rotor having a fan or propeller including thrust blades, the fan or propeller defining a closed-loop conductor.

2. An electrical aircraft engine as claimed in claim 1, wherein the thrust blades generate direct thrust by moving fluid, instead of driving a drive shaft, in turn, coupled to thrust blades.

3. An electrical aircraft engine as claimed in claim 1, wherein the thrust blades are substantially located inside or outside the stator to form a compact design.

4. An electrical aircraft engine as claimed in claim 1, wherein the tip or base of the blades define a skew angle of the rotor.

5. An electrical aircraft engine as claimed in claim 1, wherein the blades include aluminum, composite material, graphene coating, titanium material with silver coating fan blades or any combination of conductive and ferromagnetic materials.

6. An electrical aircraft engine as claimed in claim 1, wherein the fan is integrally formed as a single piece.

7. An electrical aircraft engine as claimed in claim 1, wherein the fan includes a ferromagnetic material, conductive material or a combination of both.

8. An electrical aircraft engine as claimed in claim 1, further including at least one electrical short for shorting the blades or any part of the fan.

9. An electrical aircraft engine as claimed in claim 8, wherein the short includes a hub from which the base of the blades extends.

10. An electrical aircraft engine as claimed in claim 8, wherein the short includes a link for linking the blades.

11. An electrical aircraft engine as claimed in claim 10, wherein the link is located proximal the tips or the base of the blades.

12. An electrical aircraft engine as claimed in claim 10, wherein the link includes a ring made of a conductive material, amplified by a ferromagnetic material.

13. An electrical aircraft engine as claimed in claim 8, wherein the engine includes at least one short, the shorts preferably being concentric with the fan in-between or at the base of the fan.

14. An electrical aircraft engine as claimed in claim 1, wherein the rotating magnetic field can be generated via a 1-phase, 2-phase, 3-phase or multiple-phase electricity supply.

15. An aircraft including one or more of the engines as claimed in claim 1, arranged to change the pressure of a fluid and induce movement of the aircraft.

16. An aircraft as claimed in claim 15, wherein the engines are arranged in series, or cascade or parallel with the fans directly adjacent each other.

17. A fan for a rotor, the fan including thrust blades and defining a closed-loop conductor.

18. A fan as claimed in claim 17, further including at least one electrical short for shorting the blades, the shorts including a hub from which the base of the blades extends and a link for linking the blades proximal the tips of the blades.

19. A fan as claimed in claim 18, wherein the shorts are concentric.

20. A fluid drawing induction motor including:
a stator with windings for generating a rotating magnetic field; and
a rotor for rotating inside or outside the stator, the rotor having a fan or propeller including thrust blades, the fan or propeller defining a closed-loop conductor.
